(19) United States
(12) Patent Application Publication
(10) Pub. No.: US 2011/0192738 A1
(43) Pub. Date: Aug. 11, 2011

(54) FILM WRAPPER

(75) Inventors: Juan Ramiro Uribe, Medellin (CO); Gustavo Blanco, Envigado (CO)

(73) Assignee: Philip Morris USA, Inc., Richmond, VA (US)

(21) Appl. No.: 13/016,432

(22) Filed: Jan. 28, 2011

(30) Foreign Application Priority Data
Jan. 28, 2010 (EP) 10000888.7
Nov. 30, 2010 (EP) PCT/EP2010/007256

(51) Int. Cl. B65D 85/10; B65D 65/28; B65B 11/00; B65B 51/10; B31B 1/14; B31B 1/25

(52) U.S. Cl. 206/264; 229/87.05; 53/462; 53/463; 493/363; 83/880

(57) ABSTRACT

A film wrapper comprising a tear tape, wherein an end of the tear tape terminates at a side edge of the film wrapper, and wherein a pull portion of the film wrapper is provided in the form of a protrusion at the end of the tear tape and the protrusion comprises an outer edge. An incision in the film wrapper is provided at one side of the pull portion as a continuation of the outer edge of the pull portion. A container is disclosed which comprises the aforementioned film wrapper, wherein the film wrapper is wrapped around the container. Further, a method for producing a film wrapper and a knife arrangement are disclosed.

### CROSS-REFERENCE TO RELATED APPLICATIONS

This application claims priority under 35 U.S.C. §119 and 37 C.F.R. §1.55 to PCT/EP2010/007256, filed Nov. 30, 2010, and to European Patent Application No. EP 10 000 888.7, filed Jan. 28, 2010, both of which are incorporated herein by this reference thereto.

### WORKING ENVIRONMENT

This disclosure relates generally to wrappers for use with individual packages of consumer articles. More particularly, the present disclosure concerns a wrapper including a tear strip.

The present disclosure relates to a film wrapper comprising a tear tape, wherein at least one end of the tear tape terminates at a side edge of the film wrapper, and wherein a pull portion of the film wrapper is provided in the form of a protrusion at that same end of the tear tape. The disclosure further relates to a container comprising the film wrapper, wherein the film wrapper is wrapped around the container. Furthermore, the disclosure relates to a method for producing a film wrapper, as well as a knife arrangement.

It is contemplated to package consumer goods in containers formed from folded laminar blanks. Film wrappers are contemplated that enclose the container. In order to open the container the film wrapper has to be removed. A tear tape is adhered to the film wrapper to facilitate the removal of the film wrapper. A suitable film wrapper is described in International Patent Application WO-A-2006/058864. The film wrapper provides a protruding pull tab, which facilitates grasping the pull tab and opening the film wrapper by pulling the pull tab, such that the film wrapper is ruptured at both sides of a tear tape.

Another further film wrapper is described in DE-A-2730025, wherein the tear tape protrudes from the film wrapper such that the tear tape can be grasped. To facilitate the tearing of the film wrapper, incisions can be provided at both sides of the tear tape at the side edge of the film wrapper.

It would be desirable to provide a novel film wrapper that can be removed from a container.

### SUMMARY OF SELECTED ASPECTS OF THE DISCLOSURE

According to the disclosure there is provided a film wrapper with a tear tape, wherein at least one end of the tear tape terminates at the side edge of the film wrapper, and wherein a pull portion of the film wrapper is provided in the form of a protrusion at that end of the tear tape and wherein the protrusion comprises an outer edge. According to the disclosure an incision is provided in the film wrapper at one side of the pull portion as a continuation of the outer edge of the pull portion. Due to the incision, the film wrapper will only rip along one side of the tear tape, once the consumer grasps and pulls the pull portion of the film wrapper. The remainder of the film wrapper will be removed as a whole from the container. This enables that by only one pull operation the film wrapper will be ripped along the tear line and at the same time a significant part of the container will be revealed by removing the film wrapper. In particular, a consumer can reveal the design of the container that might have been. covered before by a design on the film wrapper, with only one pull operation. This is particularly advantageous for trade dress changes in existing products. For example, the former trade dress can be provided on the film wrapper such that a consumer will recognize it on the shelf during a transition from the old to the new trade dress. After the consumer has removed the film wrapper, the consumer discovers the new trade dress.

In one embodiment, the film wrapper comprises a first connection portion on the side edge, and a second connection portion on the opposite side edge. The connection portions are connected to each other when the film wrapper is wrapped around an object. According to this embodiment of the disclosure the connection of the first connection portion and the second connection portion is detachable at a first section of the film wrapper. The first section and a second section of the film wrapper are separated by the tear tape, wherein the second section of the film wrapper comprises the incision. This enables, that during the tearing of the tear tape, the first and second connection portion of the film wrapper will be detached at least in the first section, and thus the film wrapper will be easily removed from the container.

The term “detachable” is used throughout the specification to denote that the first and second connection portions are connected such that the film wrapper is maintained around the container during handling and vending operations. However, when the tear tape is pulled, a higher force on the connection portion releases the connection of the first and second connection portion. Preferably, the first and second connection portions extend substantially in a different direction than the tear tape, preferably in a substantially perpendicular direction to the direction of the tear tape. Preferably, the connection is enabled by heat sealing. Alternatively, the connection is enabled by gluing or other techniques known in the art.

According to a second aspect of the disclosure a container is provided, the container comprising the film wrapper, wherein the film wrapper is wrapped around the container. Thus, the film wrapper is a part of the container until it is at least partially removed by ripping the tear tape. The container may be a container for any consumer goods. The container is particularly suitable for smoking articles.

Preferably, the tear tape of the film wrapper is arranged below the lower end of a lid of the container, wherein the incision is provided above the tear tape. Thus, the aforementioned arrangement of the tear tape and incision enables that the film wrapper of the lower part of the container is removed during the tearing of the tear tape, such that the design provided thereon will be revealed.

The terms “front”, “back”, “upper”, “lower”, “side”, “top”, “bottom” and other terms used to describe relative positions of the components of containers refer to the container in an upright position with the lid (where present) at the top end and a hinge (where present) on the back. The terms “left” and “right” are used with reference to side walls of the container when the container is viewed from the front in its upright position. When the container in the upright position is open, consumer articles contained in the container may be removed from the upper end of the container.

Preferably, the incision is provided substantially parallel to the tear tape. This enables, that the tearing of the film wrapper will be affected mainly in one direction and thus enabling a smooth opening process.

Preferably, the film wrapper is provided with a wrapper design different from a container design, wherein the wrapper design is at least partially covering the container design. Thus the container can have a different appearance with the film wrapper wrapped around the container and without the film wrapper. This feature is advantageous for various marketing purposes, including the transition from one container design to another, but also for other uses like providing additional space for consumer communication.

Preferably, at least two connection portions of the film wrapper are connected to each other and the container is adapted such that when the pull portion of the film wrapper is pulled, the film wrapper is ripped apart at one side of the tear tape, and along the tear tape, while at the other side of the tear tape the two connection portions of the film wrapper are separated. Thereby, the removal of the film wrapper from the container is facilitated and immediately after the beginning of the pull operation a significant portion of the film wrapper is removed from the container.

Preferably, the two connection portions of the film wrapper are connected by a heat sealing connection, which is detachable. A heat sealing connection not only provides the benefit of a fast and efficient process of fixing the film wrappers around the container, but also allows to define the force required for detachment of the heat sealing connection by adjustment of the temperature. The lower the heat sealing temperature, the easier the detachment of the heat sealing connection. Thus, a container can be provided, wherein the film wrapper is safely maintained during handling and vending operations, while during the opening process, the film wrapper can be easily removed. Advantageously, existing packaging machinery and machine configurations may be used where only some machine parameters need to be adjusted accordingly, in particular the temperature and pressure in the heat sealing means.

According to a third aspect of the disclosure a method is provided for producing a film wrapper, comprising providing a continuous film material, applying a tear tape to the film material in a substantially longitudinal direction, providing a first cut in the form of a pull portion in the film material through the film material and tear tape. Further substantially transverse second and third cuts are provided each on one side of the tear tape respectively and adjacent to the first cut to separate the film wrapper into individual film wrappers. The first cut provides a substantially longitudinal incision into the film wrapper, substantially parallel and only at one side of the tear tape. Thus, a film wrapper can be produced in an efficient manner, which comprises a generally longitudinal incision at only one side of the tear tape. When the pull portion of this film wrapper is pulled, the tearing of the film wrapper will only be affected on one side of the tear tape, and the film wrapper will be completely removed on the other side from the container around which it is wrapped. Thus, a film wrapper can be produced which facilitates the removal of the film wrapper from a container.

The provision of the first cut, the second cut and the third cut can be carried out at the same time or subsequently.

Preferably, the first cut is provided such that the pull portion protrudes from a side of the individual film wrappers. Advantageously, a protruding pull portion facilitates to grasp the pull portion during the opening process.

In one embodiment, the method further comprises the step of printing on the film material of the film wrappers. Thus, a different design can be provided on the film wrapper with respect to the design of the container around which the film wrapper may be wrapped. For example, additional information can be provided on the film wrapper.

In one embodiment, the film wrapper is wrapped around a container and is heat sealed by a sealing device, wherein at least one sealing means is associated to a first section of the film wrapper, wherein the first section of the film wrapper and a second section of the film wrapper are separated by the tear tape, and the second section comprises the incision. At least one sealing means is heated to a sealing temperature which enables providing a detachable heat sealing connection. Heat-sealing enables efficient fixation of the film wrapper around a container. The sealing temperature which enables a detachable heat sealing connection facilitates the removal of the film wrapper from the container. The sealing temperature for the detachable connection is preferably lower than a usual sealing temperature. However, the detachable connection may also be provided by other means such as special film materials. Only one or certain sealing means of the sealing device may have a lower temperature, while it is also possible that all sealing means have a lower temperature.

Preferably, the sealing temperature of the sealing means is in between about 80 degrees Celsius and about 110 degrees Celsius, preferably between about 90 degrees Celsius and about 100 degrees Celsius, most preferably, about 95 degrees Celsius. This temperature enables that the heat sealing connection is strong enough to maintain the film wrapper safely around the container during handling and vending operations, whilst it is also easily removable during the opening process. The temperatures are dependent on the material used. The ranges given are particularly advantageous for a film wrapper made from oriented polypropylene.

According to a fourth aspect of the disclosure a knife arrangement is provided, wherein the knife arrangement includes a first knife for cutting a first cut to provide a pull portion in a film material for a film wrapper, wherein the first knife comprises a blade with two blade end portions which extend in an acute angle or substantially parallel with respect to each other, wherein one blade end portion is longer than the other. Thus, this type of blade enables that the outer edge of the pull portion is cut into the film material. Additionally, this geometry enables that the longer blade end portion further cuts into the film material to provide the incision that enables the tearing process through the film wrapper material.

The blade end portions of the first knife may preferably be the legs of a J-shaped blade.

Preferably, the knife arrangement further comprises a second knife, with second and third blades for providing generally transverse second and third cuts in the film material for separating the film material into individual film wrappers. The first knife and the second knife are arranged such that the second blade is adapted to provide a second cut which ends within the first cut in the film material, provided by the longer blade end portion. The third blade is adapted to provide a third cut, which ends at the end of the first cut in the film material provided by the shorter blade end portion. Thus, at the connection of the second cut and the first cut, a portion of the first cut extends further into the film material. This provides an incision which facilitates the ripping process through the film wrapper.

Preferably, the first knife has a substantially arcuate portion connecting the two blade end portions. This enables that a pull portion is formed, which has an outer edge that prevents involuntary ripping of the film wrapper. In addition the outer edge provides an easily graspable pull portion channelling the pulling force in the direction of the incision in the film wrapper, such that the film wrapper is torn starting from the incision. The first knife may preferably have a substantially half-circular inner portion and two linear, parallel end portions.

The lid may be pivoted about a hinge in order to open the container. A hinge line may be, for example, a fold line or a score line in the back wall of the container. Alternatively, a hinge line may be a fold line or a score line in a piece of material bridging the lower edge of the back wall of the lid and the upper edge of the back wall of the box. Such a piece of material may be, for example, a label that is permanently or removably attached to the back wall of the lid and the back wall of the box. Preferably, the hinge line is positioned along the back wall of the container at a level below the upper edge of the back wall.

Preferably, the container further comprises an inner frame mounted within the box, wherein the inner frame extends above the upper edges of at least the front wall of the box of the container. The inner frame is therefore visible to the consumer when the lid is opened. The front wall of the inner frame may be printed with indicia which may be the same as, or different to the indicia printed on the front wall of the box. Alternatively, or in addition, the front wall of the inner frame may be cut into a distinctive shape, for example, to reflect the branding of the consumer goods.

Preferably, the front wall of the inner frame is provided with a cut out portion at the upper edge thereof. This enables more convenient access to the consumer goods within the container, without significantly reducing the surface area of the front wall of the inner frame.

Alternatively, or in addition to an inner frame, the consumer goods within the container may be wrapped with an inner liner, which is visible above the upper edge of the front wall of the box and the front wall of the inner frame (if present) when the container is open.

The containers may be in the shape of a rectangular parallelepiped, with substantially right-angled edges. Alternatively, the container may comprise one or more rounded longitudinal edges, rounded transverse edges, or combinations thereof. For example, the container may comprise, without limitation:

One or two rounded or bevelled edges on the front wall, and/or

One or two rounded or bevelled edges on the back wall.

One rounded edge and one bevelled edge on the front wall, and/or

One rounded edge and one bevelled edge on the back wall.

One or two rounded or bevelled edges on the front wall and one or two rounded or bevelled edges on the front wall.

Two rounded or bevelled edges on a first side wall or two rounded or bevelled edges on the second side wall.

Where the container comprises one or more rounded edges and is made from a laminar blank, preferably the blank comprises three, four, five, six or seven scoring lines or creasing lines to form the rounded edge in the assembled container. The scoring lines or creasing lines may be either on the inside of the container or on the outside of the container. Preferably, the scoring lines or creasing lines are spaced apart from each other by between about 0.3 mm and 4 mm.

Preferably, the spacing of the creasing lines or scoring lines is in function of the thickness of the laminar blank. Preferably, the spacing between the creasing lines or scoring lines is between about 0.5 and about 4 times larger than the thickness of the laminar blank.

Where the container comprises one or more bevelled edges, preferably the bevelled one or more edges have a width of between about 1 mm and about 10 mm, preferably between about 2 and about 6 mm. Alternatively, the container may comprise a double bevel formed by three parallel creasing lines or scoring lines that are spaced apart such that two distinct bevels form on the edge of the container.

Alternatively to a container with a generally rectangular cross section, the container may have a for example a generally polygonal cross section such as generally triangular, generally quadrangular or generally hexagonal, or a cross section which is generally oval, semi-oval, generally circular, or generally semi-circular.

Where the container comprises a bevelled edge and is made from a laminar blank, the bevel may be formed by two generally parallel creasing lines or scoring lines in the laminar blank. The creasing lines or scoring lines may be arranged generally symmetrically to the edge between a first wall and a second wall. Alternatively, the creasing lines or scoring lines may be arranged generally asymmetrically to the edge between the first wall and the second wall, such that the bevel extends further into the first wall of the container than into the second wall of the container.

The container may be formed from any suitable materials including, but not limited to, cardboard, paperboard, plastic, metal, or combinations thereof. Preferably, the cardboard has a weight of between about 100 grams per square metre and about 350 grams per square metre.

The containers may be used as packages for a variety of consumer goods. Containers may be advantageously used to package smoking articles including, but not limited to, known lit-end cigarettes, cigars or cigarillos, heated smoking articles comprising a combustible fuel element or heat source and an aerosol-generating substrate (for example cigarettes of the type disclosed in U.S. Pat. No. 4,714,082) and smoking articles for use with electrical smoking systems (for example cigarettes of the type disclosed in U.S. Pat. No. 5,692,525).

Through an appropriate choice of the dimensions thereof, the containers may be designed to hold different total numbers of smoking articles, or different arrangements of smoking articles. For example, through an appropriate choice of the dimensions thereof, the containers may be designed to hold a total of between ten and thirty smoking articles.

The containers may hold one, two, three four or five separate bundles of consumer goods. The separate bundles may be arranged substantially parallel to the front wall and to the back wall or substantially perpendicular to the front wall and to the back wall.

Within a bundle, the smoking articles may be arranged in different collations, depending on the total number of smoking articles, the dimensions of the smoking articles or the cross sectional shape of the container. For example, the smoking articles may be arranged in a bundle in a single row of five, six, seven, eight, nine or ten. Alternatively, the smoking articles may be arranged in two or more rows. The two or more rows may contain the same number of smoking articles. For example, the smoking articles may be arranged in: two rows of five, six, seven, eight, nine or ten; three rows of five, six, seven, eight, nine, or ten; or four rows of four, five, six or seven. Alternatively, the two or more rows may include at least two rows containing different numbers of smoking articles to each other. For example, the smoking articles may be arranged in: a row of five and a row of six (5-6); a row of six and a row of seven (6-7); a row of seven and a row of eight (7-8); a middle row of five and two outer rows of six (6-5-6); a middle row of five and two outer rows of seven (7-5-7); a middle row of six and two outer rows of five (5-6-5); a middle row of six and two outer rows of seven (7-6-7); a middle row of seven and two outer rows of six (6-7-6); a middle row of nine and two outer rows of eight (8-9-8); or a middle row of six with one outer row of five and one outer row of seven (5-6-7).

The containers may hold smoking articles of the same type or brand, or of different types or brands. In addition, both filterless smoking articles and smoking articles with various filter tips may be contained, as well as smoking articles of differing length (for example, between about 40 mm and about 180 mm), diameter (for example, between about 4 mm and about 9 mm). In addition, the smoking articles may differ in strength of taste, resistance to draw and total particulate matter delivery. Wherein the container comprises more than one bundle, each bundle within the same container may hold the same or different types of smoking articles as listed above.

Preferably, the dimensions of the container are adapted to the length of the smoking articles, and the collation of the smoking articles. Typically, the outer dimensions of the container are between about 0.5 mm to about 5 mm larger than the dimensions of the bundle of smoking articles housed inside the container.

Preferably, the containers have a height of between about 60 mm and about 150 mm, more preferably a height of between about 70 mm and about 125 mm, wherein the height is measured from the top wall to the bottom wall of the container.

Preferably, the containers have a width of between about 12 mm and about 150 mm, more preferably a width of between about 70 mm and about 125 mm, wherein the width is measured from the first side wall to the second side wall of the container.

Preferably, the containers have a depth of between about 6 mm and about 100 mm, more preferably a depth of between about 12 mm and about 25 mm wherein the depth is measured from the front wall to the back wall of the container (comprising the hinge between box and lid).

Preferably, the ratio of the height of the container to the depth of the container is in between about 0.3 to 1 and about 10 to 1, more preferably between about 2 to 1 and about 8 to 1, most preferably between about 3 to 1 and about 5 to 1

Preferably, the ratio of the width of the container to the depth of the container is in between about 1 to 1 and about 10 to 1, more preferably between about 2 to 1 and about 8 to 1, most preferably between about 2 to 1 and about 3 to 1.

Preferably, the ratio of the height of the lid back wall to the height of the box back wall is between about 0 to 1 (hinge located at the top edge of the container) to about 1 to 1, more preferably, between about 1 to 5 and about 1 to 10, most preferably, between about 1 to 6 to about 1 to 8.

Preferably, the ratio of the height of the lid front wall to the height of the box front wall is between about 1 to 0 (lid covering the entire front wall) to about 1 to 10, more preferably, between about 1 to 1 and about 1 to 5, most preferably, between about 1 to 2 and about 1 to 3.

The exterior surfaces of the containers may be printed, embossed, debossed or otherwise embellished with manufacturer or brand logos, trade marks, slogans and other consumer information and indicia. Alternatively, or in addition, the exterior surfaces of the containers may be at least partially covered with lacquer, metallisation, holograms, luminescent material, or any other materials that alter the feel, odour or appearance of the container.

Where the inner housing of the container contains one or more bundles of smoking articles, the smoking articles are preferably wrapped in an inner liner of, for example, metal foil or metallized paper.

Where the container comprises smoking articles, the container may further comprise waste-compartments or other consumer goods, for example matches, lighters, extinguishing means, breath-fresheners or electronics. The other consumer goods may be attached to the outside of the container, contained within the container along with the smoking articles, in a separate compartment of the container or combinations thereof.

Preferably, the film wrapper is made from a transparent polymeric material, for example, high or low density polyethylene, polypropylene, oriented polypropylene, polyvinylidene chloride, cellulose film, or combinations thereof. The tear tape is preferably positioned around the container below the lower edge of the front wall of the lid (where present), such that once the tear tape has been removed, the lid is free to be rotated about the first hinge line.

### BRIEF DESCRIPTION OF THE DRAWINGS

The invention will be further described, by way of example only, with reference to the accompanying drawings wherein like reference numerals are applied to like elements and wherein:

FIG. 1 is a plan view of a film material that is cut into individual film wrappers according to an embodiment to the disclosure;

FIG. 2 is a front perspective view of a container according to the disclosure comprising the film wrapper; and

FIG. 3 is a plan view of the knife arrangement according to the disclosure.

### DETAILED DESCRIPTION

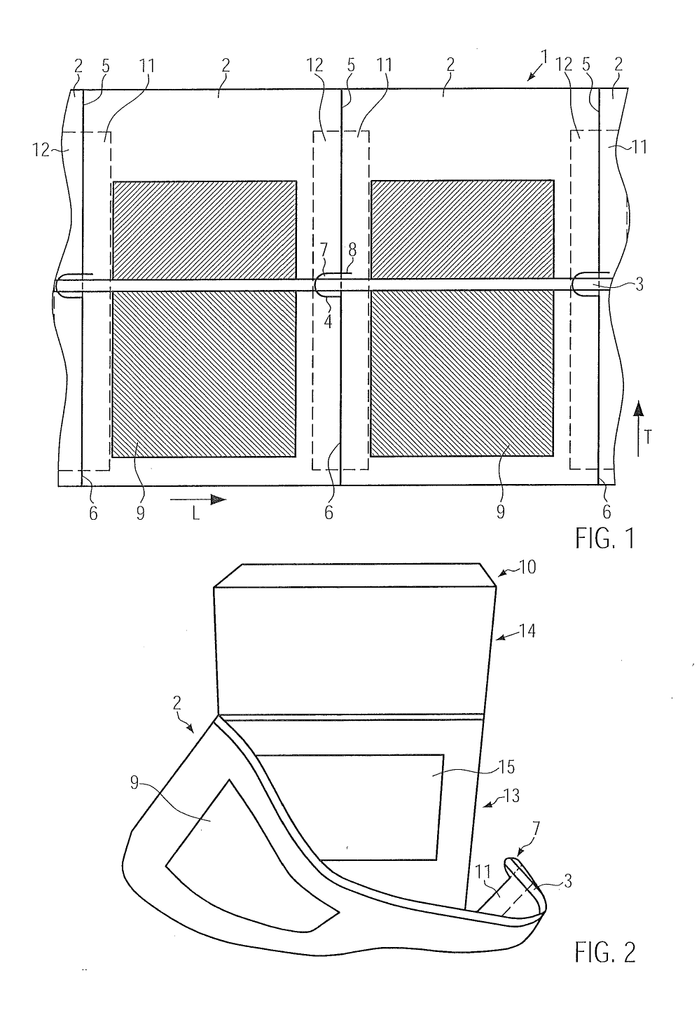

In FIG. 1 a film material 1 is depicted, which is separated into individual film wrappers 2, which can be used to be wrapped around packages, containers or the like. The film material 1 may be provided from a reel in a longitudinal direction L, and comprises a certain height in a transverse direction T.

A tear tape 3 is attached to the film material 1. In particular, the tear tape 3 can be provided from a reel in parallel to the film material 1. The tear tape 3 extends in the longitudinal direction of the film material 1. The tear tape 3 is connected by gluing or through the application of heat to the film material 1. In particular, the tear tape 3 is made of a more robust material than the film material 1, such that it withstands stronger forces, and can be used to rip open the film wrapper 2.

The film material 1 is provided with a first cut 4, a second cut 5, and a third cut 6 to separate the film material 1 and tear tape 3 into individual film wrappers 2. The first cut 4 is in the form of a pull portion 7, and has in particular a J-shaped form, wherein one of the end portions is longer than the other. The first cut 4 is also provided through the tear tape 3.

The second cut 5 extends in the transverse direction T from the side of the film material 1 to the first cut 4, and terminates within the first cut 4, such that the longer end portion of the first cut 4 forms an incision 8 in the film wrapper 2.

The third cut 6 extends in the transverse direction T from the edge of the film material 1 to the shorter end of the first cut 4, such that no incision is provided at the connection of first cut 4, and third cut 6. The third cut 6 is continued by the first cut 4.

Thus, the film material 1 is separated into individual film wrappers 2 by the first, second and third cuts 4, 5, 6.

The film wrappers 2 are provided with designs 9, which can be printed on the film material 1 before the cutting process.

In FIG. 2 a container 10 according to the disclosure comprising a film wrapper 2 is depicted. The film wrapper 2 is wrapped around the container 10, and a first connection portion 11 on the side edge of the film wrapper 2 and a second connection portion 12 on the opposite side edge are connected to each other, such that the film wrapper 2 remains wrapped around the container 10.

The connection of the first and second connection portions 11, 12 is carried out by heat sealing. However, other connection techniques, such as gluing are also possible. Further, it should be noted that each film wrapper 2 may further comprise other connection portions which are connected to each other, in particular at the top and bottom of the container 10.

The first and second connection portion 11, 12 both extend on the right side wall of the container 10 if the container is oriented as in FIG. 2, before the film wrapper 2 is unwrapped as shown in FIG. 2.

The container 10 is particularly comprised of a box 13 and a lid 14, wherein the tear tape 3 of the film wrapper 2 extends approximately one time around the container 10, just beneath the lid 14. The lid 14 is a hinge type lid, which is provided on top of a cup-shaped box 13.

The container 10 comprises a container design 15 which is provided at least on the box 13. Generally the container design 15 is also provided on the lid 14. The design 9 on the film wrapper 2, which in other parts may be transparent, is provided in such a position, that it at least partially covers the container design 15 until the film wrapper 2 is unwrapped.

During the unwrapping process, as shown in FIG. 2, the pull portion 7 of the film wrapper 2 is pulled, such that the film wrapper 2 is severed just above the tear tape 3, and that the first connection portion 11 is detached in its lower section from the second connection portion 12, which is arranged at the right side wall of the container 10. Thus, as can be seen in FIG. 2, during the opening process of the film wrapper, the container design 15, which has been covered by the film wrapper design 9, is uncovered. This provides various benefits, such as the possibility of providing more information on the container 10, and also to facilitate a transition from an old container design to a new container design. The old container design can still be provided on the film wrapper. Thus the container is easily recognized by the consumer, whilst after the removal of the film wrapper the new container design is revealed.

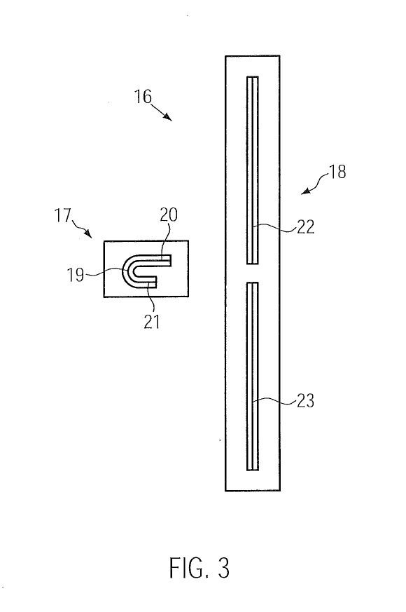

In FIG. 3 a knife arrangement 16 is depicted, which comprises a first knife 17 and a second knife 18, which can be moved individually in the cutting direction, which is normal to the figure plane.

The first knife 17, which is arranged to provide the first cut 4 in the film material 1 has a first blade 19, which comprises two blade end portions 20, 21. The blade end portion 20 is longer than the blade end portion 21. The longer blade end portion 20 is enabled to provide the incision 8 in the film wrapper 2.

The second knife 18 comprises two separate blades, namely a second blade 22 and a third blade 23. The second blade 22 is enabled to provide the second cut 5 in the film material 1, whilst the third blade 23 is enabled to provide the third cut 6 in the film material 1.

If the first knife 17 and the second knife 18 are arranged in a manner as depicted in FIG. 3, first the first knife 17 is lowered on the film material 1, such that the first cut 4 is cut into the film material 1 and through the tear tape 3. Then, the film material is moved in the longitudinal direction L, and the second knife 18 is lowered on the film material 2, such that the second and third blades 22, 23 cut the second and third cuts 5, 6 in the film material 1.

Thus, the individual film wrappers 2 are separated from each other and can be individually wrapped around containers.

An embodiment of the method of producing a film wrapper according to the disclosure comprises that film material 1 in the height of the individual film wrappers 2 is provided in a longitudinal direction L from a reel, while a tear tape 3 is also provided in the longitudinal direction L from another reel.

The tear tape 3 is then connected by the application of heat to the film material 1. Both the film material 1 and the tear tape 3, which is connected thereto, pass the knife arrangement 16 in the longitudinal direction L, and the first knife 17 is lowered on the film material 1 and cuts the U-shaped first cut 4 through the film material 1 and tear tape 3.

The film material 1 is then conveyed further in the longitudinal direction L until the first cut 4 is arranged beneath the second knife 18. The second knife 18 is lowered, such that the second blade 22 provides a second cut 5 in the film material 1, which ends within the longer end of the first cut 4, such that an incision 8 remains in the film wrapper 2. At the same time, the third blade 23 cuts a third cut 6 in the film material 1, which ends at the other end of the first cut 4, such that no incision is provided in the film wrapper 2.

Thus, the first cut 4, the second cut 5 and the third cut 6, separate the film material 1 into individual film wrappers 2, which are then wrapped around containers 10 and heat sealed by sealing means of a sealing device, wherein the connection of the first connection portion 11, and second connection portion 12 is carried out with a lower sealing temperature, such that the first connection portion and the second connection portion are detachable.

The film wrapper 2 can be removed from the container, when it is grasped and pulled at the pull portion 7, which comprises the tear tape 3. The at least two connection portions 11, 12 of the film wrapper 2, which are connected to each other, are separated at the same time as the film wrapper 2 is ripped along one side of the tear tape 3, where it comprises the incision 8. At the side of the incision 8, the two connection portions 11, 12 of the film wrapper 2 remain connected.

The knife arrangement can also only comprise one knife, which has one integral blade, wherein the transversal blade, corresponding to the third blade 23 is arranged such that the third blade 23 is a continuation of the end portion 21 of the first blade 19. The other transverse blade, which corresponds to the second blade 22, ends within the longer end portion 20 of the first blade 19.

The temperature of the sealing means of the sealing device connecting the connection portions 11, 12 of the film wrapper 2 may be generally lowered, such that all connections of the film wrapper may be detachable. However, it is preferable that the sealing temperature is only lowered in the lower sections of the first and second connection portions 11, 12, where the connection is later actually detached during the opening process, as shown in FIG. 2.

In this specification, the word “about” is sometimes used in connection with numerical values to demonstrate that numerical precision is not intended. Any such numerical value introduced by the word “about” should be interpreted to include values within a numerical tolerance of ±10% of the stated numerical value. Furthermore, the words “generally” and “substantially” are sometimes used in this specification in connection with geometric terms to demonstrate that strict geometrical definitions are not intended. For example, the expression “generally parallel” includes arrangements where strict parallelism does not exist.

It should now be apparent to those skilled in the art that a new film wrapper and method of preparation have been disclosed in the foregoing description. Moreover, it will also be apparent to those skilled in the art that numerous modifications, variations, substitutions and equivalents exist for various features that are described with particularity herein. Accordingly, it is expressly intended that all such modifications, variations, substitution, and equivalents that fall within the spirit and scope of the invention as defined by the appended claims are embraced thereby.

What is claimed is:

1. A film wrapper having a side edge and a pull portion and including a tear tape, wherein at least one end of the tear tape terminates at the side edge of the film wrapper, and wherein the pull portion of the film wrapper has the form of a protrusion at that end of the tear tape, the protrusion including an outer edge; and an incision in the film wrapper is provided at one side of the pull portion as a continuation of the outer edge of the pull portion.

2. The film wrapper according to claim 1, further including a first connection portion on the side edge and a second connection portion on an opposite side edge which are connected with each other when the film wrapper is wrapped around an object, wherein the connection of the first connection portion and the second connection portion is detachable at least at a first section of the film wrapper, wherein the tear tape separates the film wrapper into a first section and a second section, and wherein the second section of the film wrapper includes the incision.

3. A container including the film wrapper according to claim 1, wherein the film wrapper is wrapped around the container.

4. The container according to claim 3, wherein the tear tape of the film wrapper is arranged below the lower end of a container lid, and wherein the incision is provided above the tear tape.

5. The container according to claim 4, wherein the incision is provided substantially parallel to the tear tape.

6. The container according to claim 3, wherein the film wrapper is provided with a wrapper design different from a container design, and wherein the wrapper design is at least partially covering the container design.

7. The container according to claim 3, wherein at least two connection portions of the film wrapper are connected to each other, and wherein the container is adapted that when the pull portion of the film wrapper is pulled, the film wrapper is torn apart at one side of the tear tape and along the tear tape, while at the other side of the tear tape the two connection portions of the film wrapper, which are connected to each other, are separated.

8. The container according to claim 7, wherein the two connection portions of the film wrapper are connected by a heat sealing connection which is detachable.

9. A method for producing a film wrapper, comprising the steps of:
providing a continuous film material;
applying a tear tape to the film material in a substantially longitudinal direction;
providing a first cut in the form of a pull portion through the film material and tear tape;
providing a generally transverse second cut in the film material on one side of the tear tape and a generally transverse third cut in the film material on the other side of the tear tape, wherein the second and third cuts are adjacent to the first cut to separate the film material into individual film wrappers, and wherein the first cut provides a generally longitudinal incision into the film wrapper generally parallel to and at only one side of the tear tape.

10. The method according to claim 9, wherein the first cut is provided such that the pull portion protrudes from a side of individual film wrappers.

11. The method according to claim 9, wherein the film wrapper is wrapped around a container and is heat-sealed by a sealing device having multiple sealing means, wherein at least one sealing means is associated with a first section of the film wrapper, wherein the first section of the film wrapper and a second section of the film wrapper are separated by the tear tape, wherein the second section includes the incision, and wherein the at least one sealing means is heated to a sealing temperature which enables providing a detachable heat sealing connection.

12. The method according to claim 11, wherein the sealing temperature of the sealing means is in between 80 degrees Celsius and 110 degrees Celsius.

13. A knife arrangement, comprising
a first knife for cutting a first cut to provide a pull portion in a film material for a film wrapper,
wherein the first knife comprises a first blade with two blade end portions which extend in an acute angle or substantially parallel with respect to each other, wherein one blade end portion is longer than the other blade end portion.

14. The knife arrangement according to claim 13, further comprising a second knife with second and third blades for providing generally transverse second and third cuts in the film material for separating the film material into individual film wrappers, wherein the first knife and second knife are arranged such that the second blade is adapted to provide a second cut which ends within the first cut in the film material provided by the longer blade end portion, and the third blade is adapted to provide a third cut, which ends at the end of the first cut in the film material provided by the shorter blade end portion.

15. The knife arrangement according to claim 13, wherein first knife has a substantially arcuate portion connecting the two blade end portions.
